(19) United States
(12) Patent Application Publication
(10) Pub. No.: US 2026/0290678 A1
(43) Pub. Date: Sep. 24, 2026

(54) INDUCTOR PACKAGES HAVING COIL WITH WEDGE ELECTRICAL BONDS FOR INCREASED COIL CORE AREA, AND RELATED FABRICATION METHODS

(71) Applicant: QUALCOMM Incorporated, San Diego, CA (US)

(72) Inventors: Nosun Park, San Diego, CA (US); Jonghae Kim, San Diego, CA (US); Je-Hsiung Lan, San Diego, CA (US); Kai Liu, San Diego, CA (US)

(21) Appl. No.: 19/087,876

(22) Filed: Mar. 24, 2025

(51) Int. Cl. H01F 27/28; H01F 5/04; H01F 37/00; H01F 41/12

(52) U.S. Cl. CPC H01F 27/2866; H01F 5/04; H01F 37/005; H01F 41/127

(57) ABSTRACT

Inductor packages having a coil with wedge electrical bonds for increased coil core area, and related fabrication methods. To facilitate increased core area of the inductor coil for increased inductance, without having to increase the size of the inductor package, electrical bonds coupled to metal traces to form an inductor coil are provided as wedge electrical bonds. With wedge electrical bonds, it may not be necessary to provide a keep-out-zone (KOZ) outside of the metal traces to facilitate sufficient bonding. Reducing or eliminating the KOZ may also allow the metal traces to be extended in length in what would otherwise be a KOZ, to facilitate a larger coil core area for the inductors for increased inductance without enlarging the inductor package size. Use of wedge electrical bonds may also facilitate sufficient bonding to shorter length bonding sections to further facilitate a larger core area for the inductor coil.

### TECHNICAL FIELD

The field of the disclosure relates to inductor components, and more particularly to inductor packages that include an inductor formed from a coil-shaped component embedded in a substrate that can be mounted to a circuit board to provide an inductor for a circuit.

### BACKGROUND

Electronic devices, such as smartphones, laptops, and televisions, have revolutionized modern society by enabling communication, entertainment, and access to information on a global scale. These electronic devices include circuit boards, also known as “printed circuit boards” (PCBs). A PCB is an electronic assembly that includes one or more conductive layers that include metal lines or traces to provide electrical connections and electrical signal paths between electronic components coupled to the PCB. Electrical components, such as integrated circuit (IC) chips and passive electrical components, are physically mounted to a PCB to provide electrical circuity connectivity for the electrical components. The PCB electrical components are also electrically coupled to external metal interconnects (e.g., metal pads) on the PCB that are then electrically coupled to signal routing paths provided in the conductive layers of the PCB to provide electrical connections and electrical signal paths between electronic components coupled to the PCB.

One type of passive electrical component is a magnetic inductor, also referred to simply as an “inductor.” Inductors are particularly beneficial for applications requiring miniaturized, high-performance power management, such as advanced processors, automotive electronics, and 5G communication systems. An inductor includes a conductive coil that creates a magnetic field in response to changes in current for storing and releasing energy. In inductor technology, key performance indicators that are desired are higher inductance with lower direct current (DC) resistance and small body size. In this regard, inductor packages have been developed that involve a small coil-shaped component forming a conductive coil embedded in a substrate to form an inductor that is packaged and coupled to a PCB. Electrical conductors coupled to the conductive coil are exposed from the inductor package to form conductor pins for coupling to electrical pads on a PCB to provide the inductor as part of a circuit in the PCB. The substrate facilitates a small sized inductor package, because the coil-shaped component of the inductor can be formed from patterned metal traces formed on the substrate, which can be coupled together (e.g., with wire bonds) in a coil shape. By integrating inductors directly into a substrate, parasitic losses are reduced, thermal performance can be enhanced, and power density improved as compared to traditional discrete inductor designs. The embedded structure of the inductor package minimizes electromagnetic interference (EMI) and enables shorter interconnects, leading to improved signal integrity and overall system efficiency.

Because there is a general desire to continue to limit the size of electronic devices that include inductors, it is desired to further limit inductor size in inductor packages while maximizing inductance.

### SUMMARY OF THE DISCLOSURE

Aspects disclosed herein include inductor packages having a coil with wedge electrical bonds for increased coil core area, and related fabrication methods. Increased core area of an inductor core provides increased inductance over a smaller core area. The inductor package is an electrical component that includes a substrate with multiple patterned, parallel metal traces (e.g., in a lead frame, in a metallization layer) formed therein. Electrical bonds are electrically coupled to bonding sections at end portions of adjacent parallel metal traces to couple the adjacent parallel metal traces together to form an inductor coil. To facilitate an increased core area of the inductor coil to facilitate an increase in inductance without having to necessarily increase the size of the inductor package, the electrical bonds are provided as wedge electrical bonds. A wedge electrical bond is an electrical wire with end portions wedged down (i.e., pushed down/bonded) on bonding sections of parallel metal traces to electrically couple end portions of the parallel metal traces together to form the inductor coil. These wedge electrical bonds are opposed to, for example, ball bonding that involves wire bonds being melted on their ends to form bonds to the metal trace, wherein the bond balls will expand as a result of heating. Thus, ball bonding may require a keep-out-zone (KOZ) outside of the bonding sections to avoid shorting of bonding balls. With use of wedge electrical bonds to form the inductor coil in the inductor package, it may not be necessary to provide a KOZ or as large of a KOZ outside of the bonding sections. Reducing or eliminating the KOZ through use of wedge electrical bonds allows the metal traces to be extended in length in what would otherwise be a KOZ, to facilitate a larger coil core area for the inductors without enlarging the inductor package size. Use of wedge electrical bonds to form the inductor coil in the inductor package may also facilitate sufficient bonding sections to the metal traces to further facilitate a larger coil core area for the inductors without enlarging the inductor package size.

Providing an inductor package with an inductor coil with wedge electrical bonds to provide a larger core area for the inductor coil can be used to increase inductance in an inductor package without having to increase the size of the inductor package. Alternatively, providing an inductor package with an inductor coil with continuous electrical bonds can allow the inductor package to be reduced in size while maintaining the core area of the coil such that inductance is not decreased.

In other exemplary aspects, the wedge electrical bonds can be formed in contact with end portions of metal traces such that ends of the wedge electrical bonds are co-planar or substantially co-planar to the ends of the metal traces. In this manner, the width of an internal aperture of the inductor coil is maximized for a larger inductor coil area of the inductor.

In yet other exemplary aspects, the wedge electrical bonds can be formed as continuous wedge electrical bonds in a fabrication process. In this regard, a substrate is provided which includes multiple sets of parallel metal traces, with each set of parallel metal traces used to form a respective inductor coil for a separate inductor. Once the multiple inductors are formed from multiple sets of parallel metal traces, the substrate can be diced to form individual inductor packages each with an inductor coil formed from respective sets of metal traces. In this example, the wedge electrical bonds are initially formed as a continuous wire across adjacent metal traces across the multiple sets of metal traces, wherein portions of the continuous wire are wedge bonded into contact with bonding sections of metal traces in adjacent sets of metal traces. The substrate is then diced between adjacent sets of metal traces to form the individual inductor coils for each respective set of metal traces in their own respective inductor packages. The dicing of the adjacent sets of metal traces severs the wire that extended between adjacent sets of metal traces so that separate wedge electrical bonds are created to form separate respective inductor coils in each diced package. This dicing provides a termination for the wedge electrical bonds on bonding sections of the metal traces. This facilitates reduced length bonding sections in the metal traces and elimination or reduction of a KOZ to allow for providing a larger core area of the inductor coils.

In this regard, in one exemplary aspect, an inductor package is provided. The inductor package comprises a substrate and an inductor coil. The inductor coil comprises a plurality of metal traces on the substrate, the plurality of metal traces parallel to each other. Each metal trace of the plurality of metal traces comprises a first bonding section in a first plane and a second bonding section in the first plane. The inductor coil also comprises a plurality of wedge electrical bonds each comprising: a first flat end portion coupled to a second bonding section of a first metal trace of the plurality of metal traces; a second flat end portion opposite the first flat end portion, the second flat end portion coupled to a first bonding section of a second metal trace of the plurality of metal traces adjacent to the first metal trace; and a raised wire above the first plane and coupled to the flat end portion and the second flat end portion.

In another exemplary aspect, a method of fabricating an inductor package is provided. The method comprises providing a substrate. The method also comprises forming an inductor coil comprising forming a plurality of metal traces on the substrate, the plurality of metal traces parallel to each other, each metal trace of the plurality of metal traces comprising a first bonding section in a first plane and a second bonding section in the first plane. Forming the inductor coil also comprises forming a plurality of wedge electrical bonds each comprising: a first flat end portion; a second flat end portion opposite the first flat end portion; and a raised wire coupled to the flat end portion and the second flat end portion. Forming the plurality of wedge electrical bonds also comprises for each wedge electrical bond of the plurality wedge electrical bonds: coupling the first flat end portion to a second bonding section of a first metal trace of the plurality of metal traces; extending the raised wire above the first plane; and coupling the second flat end portion to a first bonding section of a second metal trace of the plurality of metal traces adjacent to the first metal trace.

In another exemplary aspect, a method of fabricating a plurality of inductor packages is provided. The method includes providing a substrate. The method also comprises forming a plurality of inductor coils, comprising: forming sets of metal traces on the substrate adjacent to each other from a street area therebeween. Each set of metal traces comprises a plurality of metal traces parallel to each other, each metal trace of the plurality of metal traces comprising a first bonding section in a first plane and a second bonding section in the first plane. Each metal trace of the plurality of metal traces in the sets of metal traces extends along a common longitudinal axis to another metal trace of the plurality of metal traces in the sets of metal traces. Forming the plurality of inductor coils also comprises forming a plurality of wedge electrical bonds each extending across aligned metal traces in the sets of metal traces extending along the common longitudinal axis. Each wedge electrical bond of the plurality of wedge electrical bonds is coupled to a first bonding section to a second bonding section of each of the aligned metal traces. The method also comprises dicing the substrate in the street areas between adjacent sets of metal traces to form a plurality of inductor packages each having an inductor coil of the plurality of inductor coils.

### BRIEF DESCRIPTION OF THE FIGURES

FIGS. 1A and 1B are perspective and side views of an exemplary inductor package that includes an inductor with an inductor coil formed from parallel metal traces formed on a substrate and bonded by wedge electrical bonds to facilitate the inductor coil having a larger core area for increased inductance without having to increase inductor package size;

FIG. 2 is a side view of the substrate in FIGS. 1A and 1B illustrating a reduced size bonding section on adjacent metal traces for forming wedge electrical bonds and the elimination of a keep-out-zone (KOZ) to facilitate forming inductor coils with a larger core area for increased inductance;

FIG. 3 is a side view of an alternative substrate with larger size bonding sections on adjacent metal traces bonded to ball bonds of wire bonds to form respective inductors coils for inductors, with a KOZ outside the bonding sections to provide process tolerance for the bonding balls;

FIG. 4 is a graph illustrating inductance performance between the inductor package in FIGS. 1A-1B as compared to an inductor package formed from inductor coils in FIG. 3;

FIG. 5 is a side view of the inductor package in FIGS. 1A and 1B;

FIG. 6 is a flowchart illustrating an exemplary fabrication process of fabricating an inductor package with an inductor that has an inductor coil formed from parallel metal traces formed on a substrate and bonded by wedge electrical bonds to facilitate the inductor coil having a larger core area for increased inductance without having to increase inductor package size, including, but not limited to, the inductor package in FIGS. 1A and 1B;

FIGS. 7A and 7B are top and side views, respectively, of a substrate that includes multiple sets of metal traces formed on a substrate, with wedge electrical bonds formed as a continuous wire across adjacent metal traces in the multiple sets of metal traces, wherein portions of the continuous wire are wedged bonded into contact with bonding sections of adjacent metal traces in multiple sets of metal traces to form a plurality of inductor coils for inductor packages like in FIGS. 1A and 1B;

FIGS. 8A and 8B is a flowchart illustrating another exemplary fabrication process of fabricating inductor packages from a substrate that includes multiple sets of metal traces formed on the substrate, with wedge electrical bonds across adjacent metal traces in the multiple sets of metal traces, including, but not limited to, the substrate in FIGS. 1A and 1B;

FIGS. 9A-9D are exemplary fabrication stages during fabrication of the inductor packages in the fabrication process in FIGS. 8A-8B;

FIG. 10 is a block diagram of an exemplary processor-based system that can be provided as or included in a circuit board that includes a mounted inductor package(s) that includes an inductor with an inductor coil formed from parallel metal traces formed on a substrate and bonded by wedge electrical bonds to facilitate the inductor coil having a larger core area for increased inductance without having to increase inductor package size, including, but not limited to, the inductor packages in FIGS. 1A-1B, 7, and 9D, and that can be fabricated according to the fabrication processes in FIGS. 6 and 8A-8B; and

FIG. 11 is a block diagram of an exemplary wireless communications device that includes radio-frequency (RF) components that can be provided as or included in a circuit board device(s) that also includes a mounted inductor package(s) that includes an inductor with an inductor coil formed from parallel metal traces formed on a substrate and bonded by wedge electrical bonds to facilitate the inductor coil having a larger core area for increased inductance without having to increase inductor package size, including, but not limited to, the inductor packages in FIGS. 1A-1B, 7, and 9D, and that can be fabricated according to the fabrication processes in FIGS. 6 and 8A-8B.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include inductor packages having a coil with wedge electrical bonds for increased coil core area, and related fabrication methods. Increased core area of an inductor core provides increased inductance over a smaller core area. The inductor package is an electrical component that includes a substrate with multiple patterned, parallel lead frames (i.e., in a lead frame, in a metallization layer) formed therein. Electrical bonds are electrically coupled to bonding sections at end portions of adjacent parallel metal traces to couple the adjacent parallel metal traces together to form an inductor coil. To facilitate an increased core area of the inductor coil to facilitate an increase in inductance without having to necessarily increase the size of the inductor package, the electrical bonds are provided as wedge electrical bonds. A wedge electrical bond is an electrical wire with end portions wedged down (i.e., pushed down/bonded) on bonding sections of parallel metal traces to electrically couple end portions of the parallel metal traces together to form the inductor coil. These wedge electrical bonds are opposed to, for example, ball bonding that involves wire bonds being melted on their ends to form bonds to the metal trace, wherein the bond balls will expand as a result of heating. Thus, ball bonding may require a keep-out-zone (KOZ) outside of the bonding sections to avoid shorting of bonding balls. With use of wedge electrical bonds to form the inductor coil in the inductor package, it may not be necessary to provide a KOZ or as large of a KOZ outside of the bonding sections. Reducing or eliminating the KOZ through use of wedge electrical bonds allows the metal traces to be extended in length in what would otherwise be a KOZ, to facilitate a larger coil core area for the inductors without enlarging the inductor package size. Use of wedge electrical bonds to form the inductor coil in the inductor package may also facilitate sufficient bonding sections to the metal traces to further facilitate a larger coil core area for the inductors without enlarging the inductor package size.

Providing an inductor package with an inductor coil with wedge electrical bonds to provide a larger core area for the inductor coil can be used to increase inductance in an inductor package without having to increase the size of the inductor package. Alternatively, providing an inductor package with an inductor coil with continuous electrical bonds can allow the inductor package to be reduced in size while maintaining the core area of the coil such that inductance is not decreased.

In yet other exemplary aspects, the wedge electrical bonds can be formed as continuous wedge electrical bonds in a fabrication process. In this regard, a substrate is provided which includes multiple sets of parallel metal traces, with each set of parallel metal traces used to form a respective inductor coil for a separate inductor. Once the multiple inductors are formed from multiple sets of parallel metal traces, the substrate can be diced to form individual inductor packages each with an inductor coil formed from respective sets of metal traces. In this example, the wedge electrical bonds are initially formed as a continuous wire across adjacent leads frames in the multiple sets of metal traces, wherein portions of the continuous wire are wedge bonded into contact with bonding sections of metal traces in adjacent sets of metal traces. The substrate is then diced between adjacent sets of metal traces to form the individual inductor coils for each respective set of metal traces in their own respective inductor packages. The dicing of the adjacent sets of metal traces severs the wire that extended between adjacent sets of metal traces so that separate wedge electrical bonds are created to form separate respective inductor coils in each diced package. This dicing provides a termination for the wedge electrical bonds on bonding sections of the metal traces. This facilitates reduced length bonding sections in the metal traces and elimination or reduction of a KOZ to allow for providing a larger core area of the inductor coils.

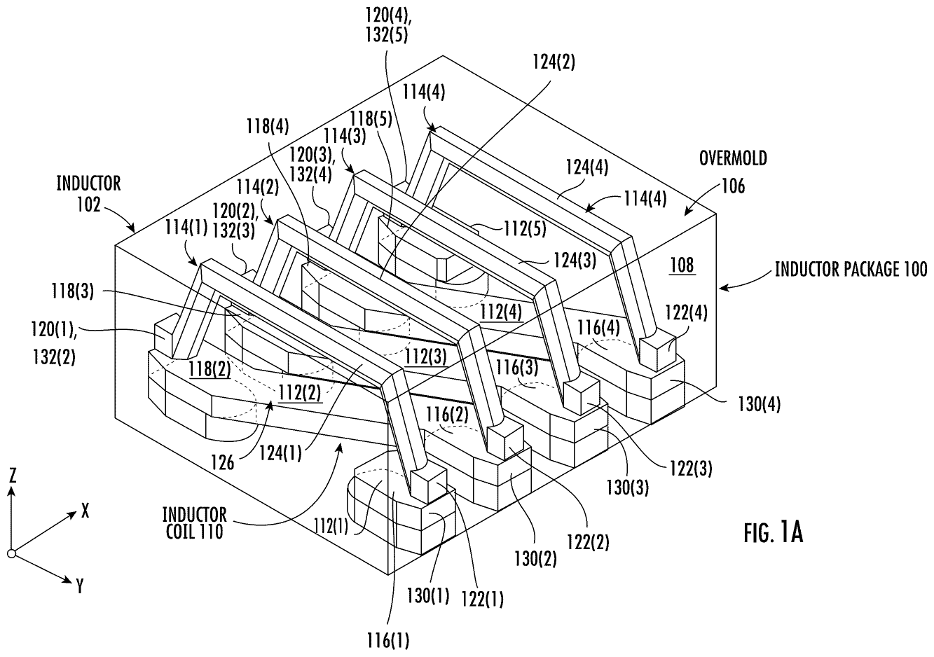

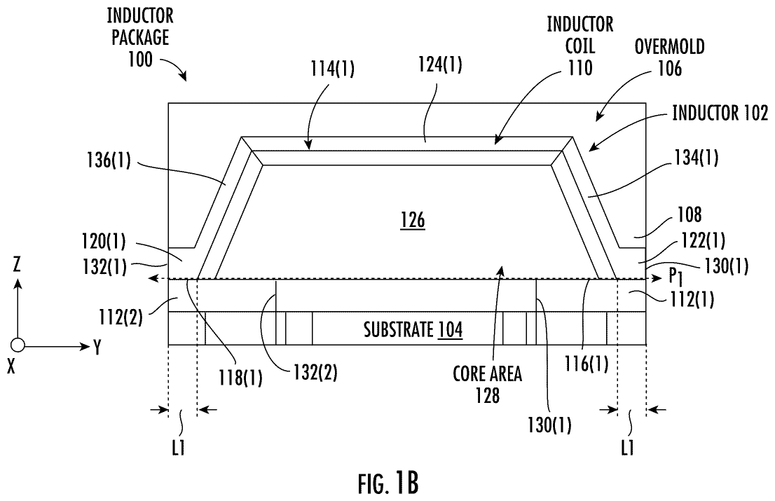

In this regard, FIGS. 1A and 1B are perspective and side views of an exemplary inductor package 100 that includes an inductor 102. As shown in FIG. 1B, the inductor 102 is formed on a substrate 104 with an overmold 106 of an overmolding material 108 formed thereon. The overmolding material 108 could be a magnetic material or an epoxy molding compound (EMC) as examples. The side view of the inductor package 100 in FIG. 1B is in the X-axis direction in the perspective view of the inductor package 100 in FIG. 1A. As shown in FIGS. 1A and 1B, the inductor 102 is formed from an inductor coil 110 that is formed from metal traces 112(1)-112(5) that are parallel to each other (“parallel metal traces” 112(1)-112(5)) and formed on the substrate 104 and bonded by wedge electrical bonds 114(1)-114(4). In one example, the metal traces 112(1)-112(5) can be provided as part of a lead frame disposed on the substrate 104. A lead frame is a thin patterned metal structure used to connect small electrical terminals on a substrate or other surface. In another example, the metal traces 112(1)-112(5) can be formed as part of a metallization layer formed on the substrate 104, such as a laminated metallization layer or embedded trace substrate. Metal traces 112(1)-112(4) include a respective first bonding section 116(1)-116(4) in a first plane P1 in the X and Y-axes directions, and metal traces 112(2)-112(5) includes a respective second bonding section 118(2)-118(5) also in the first plane P1. A bonding section of a metal trace is a section of the metal trace that is designated or designed to receive a bonded metal material to form an electrical connection to the metal trace. Note that metal trace 112(1) does not include a second bonding section, and metal trace 112(5) does not include a first bonding section. The wedge electrical bonds 114(1)-114(4) each include respective first flat end portions 120(1)-120(4) coupled to respective second bonding sections 118(2)-118(5) of the respective metal traces 112(2)-112(5), and respective second flat end portions 122(1)-122(4) coupled to respective first bonding sections 116(1)-116(4) of the respective metal traces 112(1)-112(4). By “flat end” portion of a wedge electrical bond, it is meant that there is a portion at or adjacent to the end of a wedge electrical bond that has a flat surface. The wedge electrical bonds 114(1)-114(4) also each include a respective raised wire 124(1)-124(4) raised above the first plane P1 and coupled to respective first flat end portions 120(1)-120(4) and second flat end portions 122(1)-122(4) to couple each first flat end portion 120(1)-120(4) to a respective second flat end portion 122(1)-122(4).

In this regard, the wedge electrical bonds 114(1)-114(4) that form the inductor coil 110 of the inductor 102 in the inductor package 100 are formed by the raised wires 124(1)-124(4) with their respective first and second flat end portions 120(1)-120(4), 122(1)-122(4) wedged down (i.e., pushed down/bonded) on the respective second and first bonding sections 118(2)-118(5), 116(1)-116(4) of the parallel metal traces 112(1)-112(5). This electrically couples the first and second flat end portions 120(1)-120(4), 122(1)-122(4) onto the respective first bonding sections 116(1)-116(4) to the respective second bonding sections 118(2)-118(5) to form the inductor coil 110. In this example, the first and second flat end portions 120(1)-120(4), 122(1)-122(4) are parallel to the first and second bonding sections 116(1)-116(4), 118(2)-118(5) in the X-axis and Y-axis directions. As shown in FIG. 1B, the space formed between the wedge electrical bonds 114(1)-114(4) and the metal traces 112(1)-112(5) forms an aperture 126 that provides a core area 128 of the inductor coil 110. As will be discussed in more detail below, this way of forming the inductor coil 110 with the wedge electrical bonds 114(1)-114(4) facilitates an increased core area 128 of the inductor coil 110 to facilitate an increase in inductance without having to necessarily increase the size of the inductor package 100.

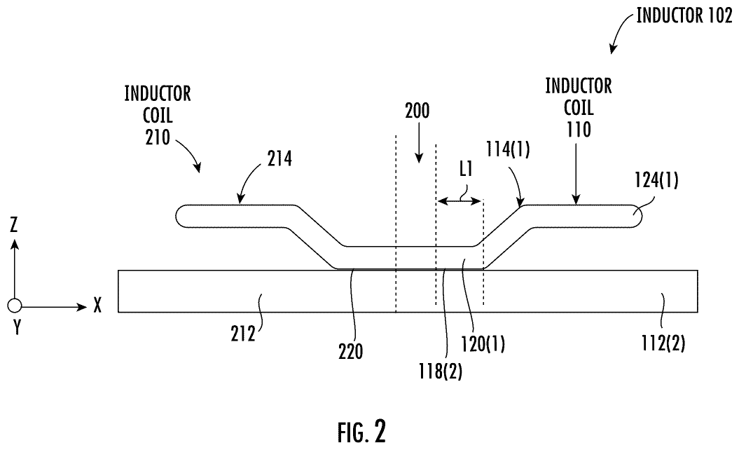

With use of the wedge electrical bonds 114(1)-114(4) to form the inductor coil 110, it may not be necessary to provide a KOZ or as large of a KOZ outside of the bonding sections, as shown in FIG. 2. FIG. 2 shows a side view of the wedge electrical bond 114(1) in the inductor coil 110 in FIGS. 1A and 1B. As shown therein, the first flat end portion 120(1) of the wedge electrical bond 114(1) is wedged/pushed down in contact with the second bonding section 118(2) of the metal trace 112(2). As discussed in more detail below, the metal trace 112(2) may have been originally formed to be adjacent to another metal trace 212 that forms another adjacent inductor coil 210 on a substrate and wedge electrical bond 214 with its own flat end portion 220 coupled to the metal trace 212 before being diced into its own separate inductor package 100. As also discussed in more detail below, the wedge electrical bonds 114(1), 214 may have been originally formed with a single step wedge bond process, wherein a center street area 200 between the adjacent metal traces 212, 112(2) is cut to separately form inductor coils. By providing the wedge electrical bond 114(1) as a form of bonding to form the inductor coil 110, an additional KOZ is not required to be provided on each side of the center street area 200 between the center street area 200 and the metal traces 112(2), 212 in this example. Reducing or eliminating the KOZ through use of the wedge electrical bonds 114(1)-114(4) in the inductor package 100 in FIGS. 1A and 1B allows the metal traces 112(1)-112(5) to be extended in length in what would otherwise be a KOZ, to facilitate a larger coil core area 128 for the inductor 102 without enlarging the size of the inductor package 100.

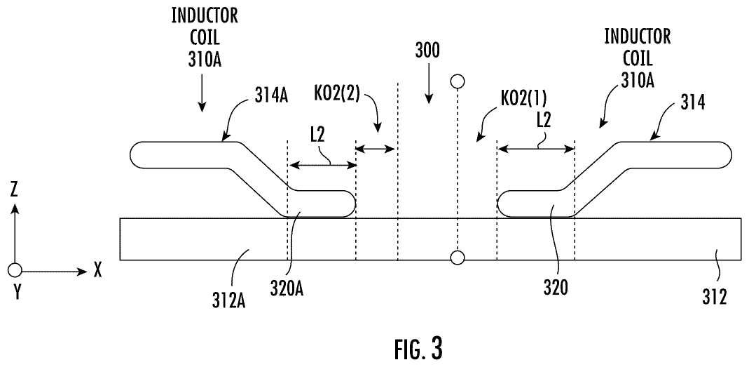

This is in contrast to, for example, ball bonding that involves wire bonds being formed and melted on their ends to form bonds to a metal trace, wherein the bond balls will expand as a result of heating. This is shown in a side view of alternative inductor coils 310, 310A in FIG. 3. As shown in FIG. 3, two adjacent wire bonds 314, 314A are coupled to respective adjacent metal traces 312, 312A to form the respective inductor coils 310, 310A, which can be diced in the center area 300 to form respective separate inductor packages. As shown in FIG. 3, with the inductor coils 310, 310A formed with ball bonds 320, 320A, the ball bonds 320, 320A expand in length L2 over the length L1 of the flat end portions 120(1), 220 in FIG. 2 as a result of heating. For example, the length L1 of the flat end portions 120(1)-120(4), 122(1)-122(4) of the wedge electrical bonds 114(1)-114(4) in the inductor package 100 in FIGS. 1A and 1B may be one hundred (100) micrometers (μm). This is in contrast to the longer length L2 of the ball bonds 320, 320A of the wire bonds 314, 314A, which may be 475 μm for example. The use of the wire bonds 314A, 314A with the ball bonds 320, 320A shown in FIG. 3 requires that keep-out-zones KOZ(1), KOZ(2) be provided on each side of the center area 300 that will be diced, so that there is room for expansion of the ball bonds 320, 320A without causing shorts. Thus, inductor packages formed with inductor coils 310, 310A like in FIG. 3 will require an expanded package size for the same inductance as compared to the inductor package 100 in FIGS. 1A and 1B due to the reduction or elimination of a need of KOZs when fabricating the inductor package 100. Thus, the inductor 102 of the inductor package 100 in FIGS. 1A and 1B can have the same or larger coil core area 128 to maintain or increase inductance, as compared to the inductor coils 310, 310A like in FIG. 3, without having to enlarge the size of the inductor package 100.

Further, in this example, as shown in the inductor package 100 in FIGS. 1A and 1B, the metal traces 112(1), 112(2) include respective first and second metal trace ends 130(1)-130(4), 132(2)-132(5). The first and second bonding sections 116(1)-116(4), 118(2)-118(5) are adjacent and/or co-planar to the respective first and second metal trace ends 130(1)-130(4), 132(2)-132(5) in the vertical, Z-axis direction. This is to maximize the length of the core area 128 in the Y-axis direction of the inductor coil 110 as shown in FIG. 1B to maximize inductance. Further, in this example, the first flat end portions 120(1)-120(4) and the second flat end portions 122(1)-122(4) of the respective wedge electrical bonds 114(1)-114(4) are co-planar with the respective first and second metal trace ends 130(1)-130(4), 132(2)-132(5) of the metal traces 112(1)-112(5), again to maximize the length of the core area 128 of the inductor coil 110 in the Y-axis direction, as shown in FIG. 1B, to maximize inductance.

Further, in this example, as shown in FIGS. 1A and 1B, the wedge electrical bonds 114(1)-114(4) each have a U-shape, wherein the bottom of the U-shape is provided by the raised wires 124(1)-124(4) raised from the first flat end portions 120(1)-120(4) and the second flat end portions 122(1)-122(4) in the vertical, Z-axis direction. The wedge electrical bonds 114(1)-114(4) each have a trapezoid shape. As shown in FIG. 1B, using example wedge electrical bond 114(1), which is applicable to the other wedge electrical bonds 114(2)-114(3), the wedge electrical bond 114(1) also includes first and second angled electrical wires 134(1), 136(1) that are coupled between the respective first and second flat end portions 120(1), 122(2) and the raised wire 124(1). The first and second angled electrical wires 134(1), 136(1) are angled with respect to the raised wire 124(1) and first and second flat end portions 120(1), 122(2), which are parallel to each other in the Y-axis direction.

FIG. 4 is a graph 400 illustrating inductance performance between the inductor 102 that includes the inductor coil 110 in inductor package 100 in FIGS. 1A-1B as compared to an inductor formed from the inductor coils 310, 310A in FIG. 3. As shown in FIG. 4, the inductance (shown on the Y-axis) of the inductor 102 in the inductor package 100 in FIGS. 1A-1B is higher as a function of frequency (shown on the X-axis) than an inductor formed from the inductor coils 310, 310A in FIG. 3 for a given same or similarly sized inductor package.

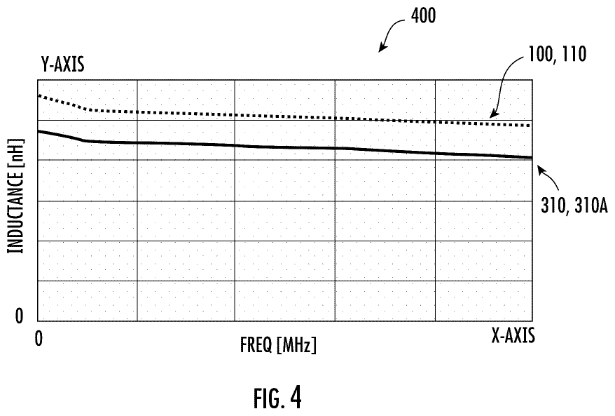

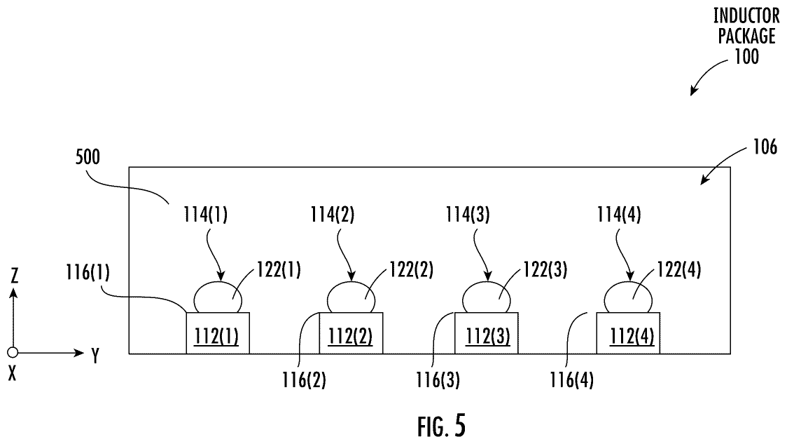

FIG. 5 illustrates a side view of the inductor package 100 in FIGS. 1A and 1B with the metal traces 112(1)-112(4) and the second flat end portions 122(1)-122(4) of the wedge electrical bonds 114(1)-114(4) coupled to the first bonding sections 116(1)-116(4) and exposed from the overmold 106. As discussed in more detail below, the second flat end portions 122(1)-122(4) of the wedge electrical bonds 114(1)-114(4) are exposed from a first side 500 of the overmold 106 of the inductor package 100 as a result of the wedge electrical bonds 114(1)-114(4) being formed as a continuous process. Note that although not shown in FIG. 4, the first flat end portions 120(1)-120(4) of the wedge electrical bonds 114(1)-114(4) shown in FIGS. 1A and 1B and coupled to the second bonding sections 118(2)-118(5) of the respective metal traces 112(2)-112(5) are exposed from a second side of the overmold 106 opposite the first side 500 in the X-axis direction.

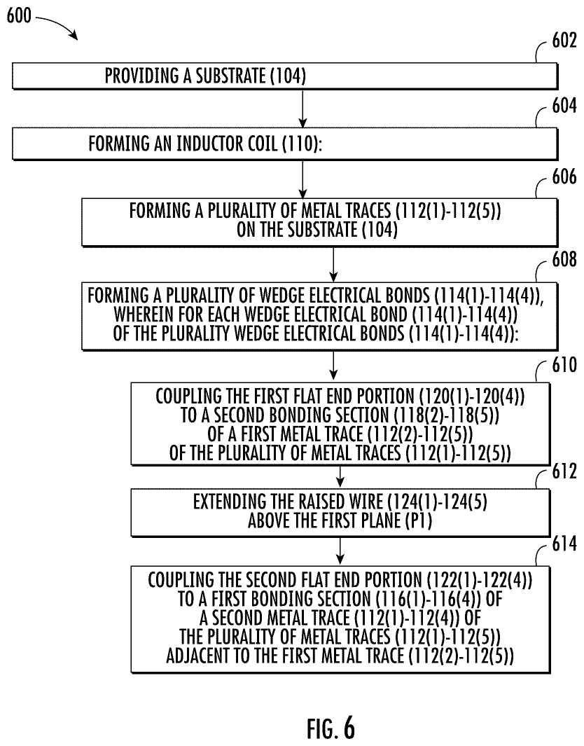

A fabrication process can be employed to fabricate an inductor package that includes an inductor with an inductor coil formed from parallel metal traces formed on a substrate and bonded by wedge electrical bonds to facilitate the inductor coil having a larger core area for increased inductance without having to increase inductor package size, including, but not limited to, the inductor package 100 in FIGS. 1A and 1B. In this regard, FIG. 6 is a flowchart illustrating an exemplary fabrication process 600 of fabricating an inductor package that includes an inductor with an inductor coil formed from parallel metal traces formed on a substrate and bonded by wedge electrical bonds to facilitate the inductor coil having a larger core area for increased inductance without having to increase inductor package size, including, but not limited to, the inductor package 100 in FIGS. 1A and 1B. The fabrication process 600 in FIG. 6 is discussed with regard to the inductor package 100 in FIGS. 1A and 1B as an example, but note that the fabrication process 600 in FIG. 6 is not limited to fabricating the inductor package 100 in FIGS. 1A and 1B. The fabrication process 600 in FIG. 6 could be used to fabricate another inductor package that includes an inductor with an inductor coil formed from parallel metal traces formed on a substrate and bonded by wedge electrical bonds to facilitate the inductor coil having a larger core area for increased inductance without having to increase inductor package size.

In this regard, as shown in FIG. 6, a first step in the fabrication process 600 can be providing a substrate 104 (block 602 in FIG. 6). A next step in the fabrication process 600 can be forming an inductor coil 110 (block 604 in FIG. 6). Forming the inductor coil 110 can include forming a plurality of metal traces 112(1)-112(5) on the substrate 104 (block 606 in FIG. 6). The plurality of metal traces 112(1)-112(5) are parallel to each other. Each metal trace 112(1)-112(5) of the plurality of metal traces 112(1)-112(5) comprises a first bonding section 116(1)-116(4) in the first plane P1 and a second bonding section 118(2)-118(5) in the first plane P1. A next step in forming the inductor coil 110 can be forming a plurality of wedge electrical bonds 114(1)-114(4) (block 608 in FIG. 6). Forming the plurality of wedge electrical bonds 114(1)-114(4) can include, for each wedge electrical bond 114(1)-114(4) of the plurality wedge electrical bonds 114(1)-114(4) (block 608 in FIG. 6), coupling the first flat end portion 120(1)-120(4) to a second bonding section 118(2)-118(5) of the first metal trace 112(2)-112(5) of the plurality of metal traces 112(1)-112(5) (block 610 in FIG. 6), extending the raised wire 124(1)-124(5) above the first plane P1 (block 612 in FIG. 6), and coupling the second flat end portion 122(1)-122(4) to a first bonding section 116(1)-116(4) of a second metal trace 112(1)-112(4) of the plurality of metal traces 112(1)-112(5) adjacent to the first metal trace 112(2)-112(5) (block 614 in FIG. 6).

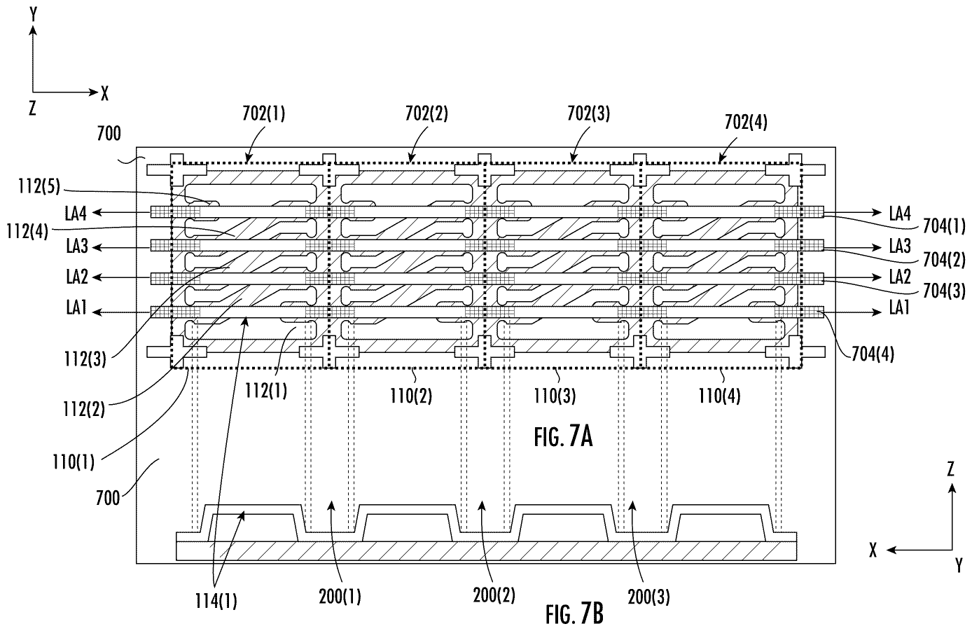

Wedge electrical bonds in an inductor coil, such as the wedge electrical bonds 114(1)-114(4) used to form the inductor coil 110 in the inductor package 100 in FIGS. 1A and 1B, can be formed as continuous wedge electrical bonds in a fabrication process. This is shown by example in FIGS. 7A and 7B, which are top and side views, respectively, of a substrate 700. As shown in FIGS. 7A and 7B, multiple sets of metal traces 702(1)-702(4) are formed on the substrate 700. Each set of metal traces 702(1)-702(4) is separated by a vertical street area in the Y-axis direction that provides cut out areas and that do not need to include a KOZ as previously discussed, for example, in regard to FIG. 2. Each set of metal traces 702(1)-702(4) can be like the metal traces 112(1)-112(5) in FIGS. 1A and 1B as an example. Metal traces 112(1)-112(5) are shown for the set of metal traces 702(1) for this example. Note that metal traces 112(1) are aligned and adjacent to the other metal traces 112(2) for the other sets of metal traces 702(2)-702(4) along longitudinal axes L1-L4 in the X-axis direction., and the same is true for metal traces 112(2)-112(5) in the other sets of metal traces 702(2)-702(4). In this example, the wedge electrical bonds 114(1)-114(4) are formed as a continuous wire 704(1)-704(4) across adjacent metal traces 112(1)-112(4) in each of the respective multiple sets of metal traces 702(1)-702(4). Flat end portions 120(1)-120(4), 122(1)-122(4) of the respective continuous wires 704(1)-704(4) are wedge bonded into contact with bonding sections of adjacent metal traces 112(1)-112(4) in each of the respective multiple sets of metal traces 702(1)-702(4) as a wedge bonding process. This forms a plurality of inductor coils 110(1)-110(4) like the inductor coil 110 in the inductor package 100 in FIGS. 1A and 1B from the formation of the wedge electrical bonds 114(1)-114(4) from the continuous wires 704(1)-704(4) bonded to the respective metal traces 112(1)-112(4) in each set of metal traces 702(1)-702(4).

Once the inductor coils 110(1)-110(4) are formed from the coupling of the wedge electrical bonds 114(1)-114(4) from the wedging of the continuous wire 704(1)-704(4) across and into contact with bonding sections of adjacent metal traces 112(1)-112(4) in each of the respective multiple sets of metal traces 702(1)-702(4), the inductor coils 110(1)-110(4) are diced by cutting into the continuous wire 704(1)-704(4) and the substrate 700 in the street areas 200(1)-200(3). This forms separate inductor packages from the respective inductor coils 110(1)-110(4). The formation of the wedge electrical bonds 114(1)-114(4) for each of the multiple sets of metal traces 702(1)-702(4) allows a sufficient bonding to be provided to form the inductor coils 110(1)-110(4) while eliminating or minimizing the need for any KOZs on the sides of the street areas 200(1)-200(3). This is shown in FIG. 2, which shows inductor coils 110, 210 formed from adjacent metal traces 112(2), 212, which could be from adjacent metal traces from the sets of metal traces 702(1)-702(4) in FIGS. 7A and 7B.

Other fabrication processes can be employed to fabricate inductor packages that include an inductor with an inductor coil formed from parallel metal traces formed on a substrate and bonded by wedge electrical bonds to facilitate the inductor coil having a larger core area for increased inductance without having to increase inductor package size, including, but not limited to, the inductor package 100 in FIGS. 1A and 1B, and the inductors coils 110(1)-110(4) in FIGS. 7A and 7B, to be diced into individual inductor packages.

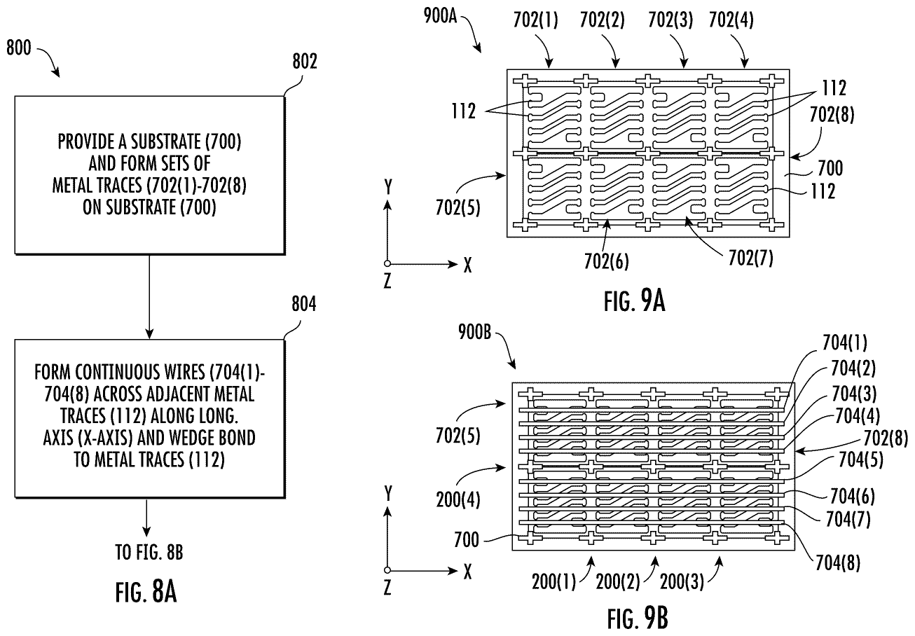

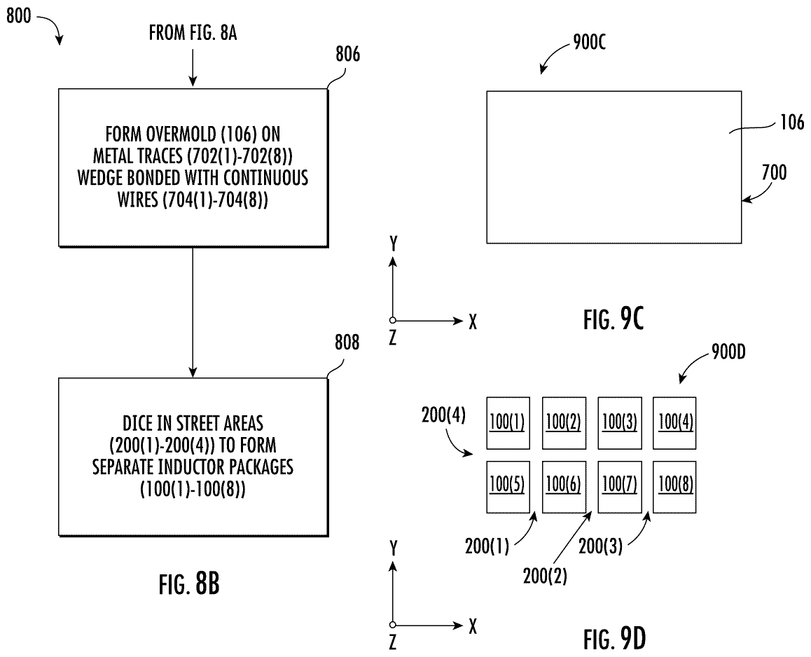

In this regard, FIGS. 8A-8B illustrate a process of fabricating inductor packages from a substrate that includes multiple sets of metal traces formed on the substrate, with wedge electrical bonds across adjacent metal traces in the multiple sets of metal traces, including, but not limited to, the substrate 700 in FIGS. 7A and 7B. FIGS. 9A-9D are exemplary fabrication stages 900A-900D during fabrication of inductor packages from a substrate that includes multiple sets of metal traces formed on the substrate, with wedge electrical bonds across adjacent leads frames in the multiple sets of metal traces, according to the fabrication process 800 in FIGS. 8A-8B. The fabrication process 800 will be discussed in conjunction with the fabrication stages 900A-900D in FIGS. 9A-9D. The fabrication process 800 in FIGS. 8A-8B is discussed with regard to the substrate 700 and the inductor coils 110(1)-110(4) formed therein in FIGS. 7A and 7B, but note that the fabrication process 800 in FIGS. 8A-8B is not limited to fabricating the substrate 700 and the inductor coils 110(1)-110(4) formed therein in FIGS. 7A and 7B.

In this regard, as shown in the exemplary fabrication stage 900A in FIG. 9A, a first step in the fabrication process 800 can be providing the substrate 700 and forming the sets of metal traces 702(1)-702(8) on the substrate 700 that will be used to form inductor coils (block 802 in FIG. 8A). Then, as shown in the exemplary fabrication stage 900B in FIG. 9B, a next step in the fabrication process 800 can be forming the continuous wires 704(1)-704(8) across adjacent metal traces 112 in the multiple sets of metal traces 702(1)-702(8) and wedge bond the continuous wires 704(1)-704(8) to the respective metal traces 112 (e.g., like discussed in the inductor package 100 in FIGS. 1A and 1B) (block 804 in FIG. 8A). Then, as shown in the exemplary fabrication stage 900C in FIG. 9C, a next step in the fabrication process 800 can be forming the overmold 106 on the sets of metal traces 702(1)-702(8) that are wedge bonded with the respective continuous wires 704(1)-704(8) (block 806 in FIG. 8B). Then, as shown in the exemplary fabrication stage 900D in FIG. 9D, in a next step in the fabrication process 800 can be to dice the continuous wires 704(1)-704(8) and the substrate 700 along the street areas 200(1)-200(3) in the Y-axis direction and along the street area 204(4) in the X-axis direction to form individual inductor packages 100(1)-100(8) each like the inductor package 100 in FIGS. 1A and 1B.

Note as discussed herein, the term “couple” can mean directly connected or indirectly connected. When two objects are directly connected, there is no intervening component connected between the two objects. When two objects are indirectly connected, there may be an intervening component(s) connected between the two coupled objects.

It should be understood that the terms “first,” “second,” “third,” etc., where used herein, are relative terms that may be used to distinguish between similarly named elements and are not meant to limit or imply a strict orientation and/or order unless otherwise specified. It should also be understood that that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

An inductor package that includes an inductor with an inductor coil formed from parallel metal traces formed on a substrate and bonded by wedge electrical bonds to facilitate the inductor coil having a larger core area for increased inductance without having to increase inductor package size, including, but not limited to, the inductor packages 100 and inductor coils 110(1)-110(4) in FIGS. 1A-1B, 7A-7B, and 9D, and that can be fabricated according to, but not limited to, the exemplary fabrication processes 600, 800 in FIGS. 6 and 8A-8B, may be provided or integrated in an electronic device, IC package, and/or any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

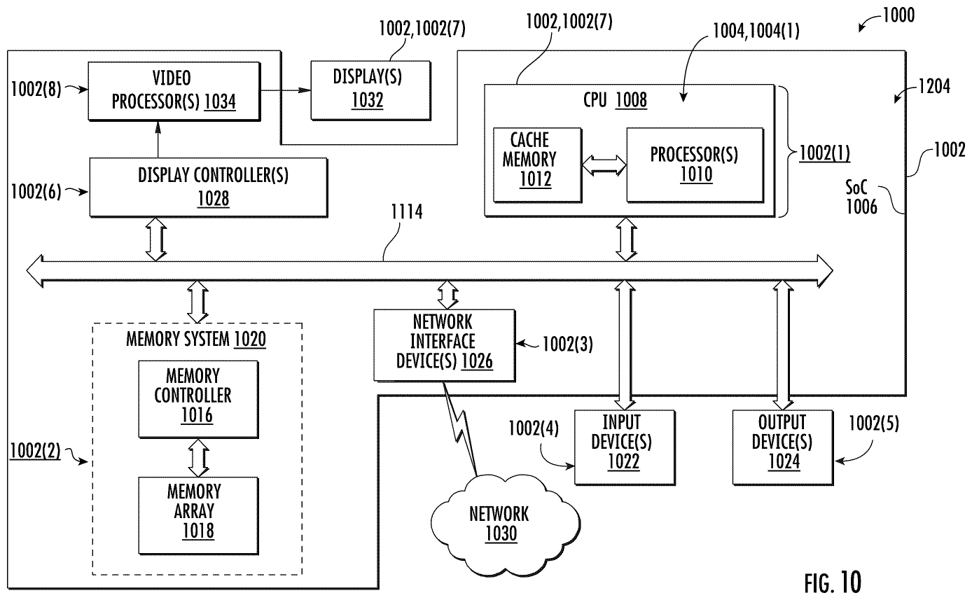

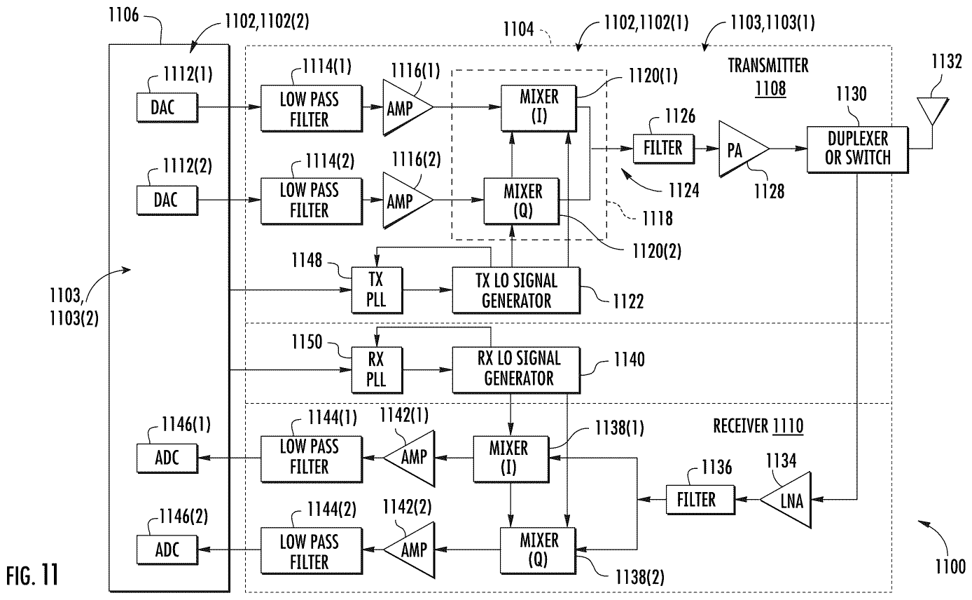

In this regard, FIG. 10 illustrates an example of a processor-based system 1000 that can include one or more inductor packages 1002, 1002(1)-1002(8) that includes an inductor with an inductor coil formed from parallel metal traces formed on a substrate and bonded by wedge electrical bonds to facilitate the inductor coil having a larger core area for increased inductance without having to increase inductor package size, including, but not limited to, the inductor packages 100 and inductor coils 110(1)-110(4) in FIGS. 1A-1B, 7A-7B, and 9D, and that can be fabricated according to, but not limited to, the exemplary fabrication processes 600, 800 in FIGS. 6 and 8A-8B.

In this example, the processor-based system 1000 may be provided in an IC 1004, such as a system-on-a-chip (SoC) 1006. The processor-based system 1000 includes a central processing unit (CPU) 1008 that includes one or more processors 1010, which may also be referred to as CPU cores or processor cores. The CPU 1008 may be coupled to an inductor package 1002(1). The CPU 1008 may have cache memory 1012 coupled to the CPU 1008 for rapid access to temporarily stored data. The CPU 1008 is coupled to a system bus 1014 and can intercouple controlling and controlled devices included in the processor-based system 1000. As is well known, the CPU 1008 communicates with these other devices by exchanging address, control, and data information over the system bus 1014. For example, the CPU 1008 can communicate bus transaction requests to a memory controller 1016, as an example of a controlled device. Although not illustrated in FIG. 10, multiple system buses 1014 could be provided, wherein each system bus 1014 constitutes a different fabric.

Other controlling and controlled devices can be connected to the system bus 1014. As illustrated in FIG. 10, these devices can include a memory system 1020 that includes the memory controller 1016 and a memory array(s) 1018, one or more input devices 1022, one or more output devices 1024, one or more network interface devices 1026, and one or more display controllers 1028, as examples, that may be coupled to respective inductor packages 1002(2)-1002(6). The input device(s) 1022 can include any type of input device, including, but not limited to, input keys, switches, voice processors, etc. The output device(s) 1024 can include any type of output device, including, but not limited to, audio, video, other visual indicators, etc. The network interface device(s) 1026 can be any device configured to allow exchange of data to and from a network 1030. The network 1030 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 1026 can be configured to support any type of communications protocol desired.

The CPU 1008 may also be configured to access the display controller(s) 1028 over the system bus 1014 to control information sent to one or more displays 1032. The display controller(s) 1028 sends information to the display(s) 1032 to be displayed via one or more video processors 1034, which process the information to be displayed into a format suitable for the display(s) 1032. The display 1032 can have an inductor package(s) 1002(8). The display(s) 1032 can include any type of display, including, but not limited to, a cathode ray tube (CRT), a liquid crystal display (LCD), a plasma display, a light emitting diode (LED) display, etc. The display 1032 may be coupled to an inductor package 1002(7).

FIG. 11 illustrates an exemplary wireless communications device 1100 that includes radio frequency (RF) components that can include one or more inductor packages 1102, 1102(1)-1102(2) that include an inductor with an inductor coil formed from parallel metal traces formed on a substrate and bonded by wedge electrical bonds to facilitate the inductor coil having a larger core area for increased inductance without having to increase inductor package size, including, but not limited to, the inductor packages 100 and inductor coils 110(1)-110(4) in FIGS. 1A-1B, 7A-7B, and 9D, and that can be fabricated according to, but not limited to, the exemplary fabrication processes 600, 800 in FIGS. 6 and 8A-8B. The wireless communications device 1100 may be included or be provided in any of the above-referenced devices, as examples. The wireless communications device 1100 may be provided in an IC 1103. As shown in FIG. 11, the wireless communications device 1100 includes a transceiver 1104 and a data processor 1106. The transceiver 1104 and a data processor 1106 can be coupled to respective or the same inductor packages 1102(1), 1102(2) and/or may be included in respective or the same ICs 1103(1), 1103(2). The data processor 1106 may include a memory to store data and program codes. The transceiver 1104 includes a transmitter 1108 and a receiver 1110 that support bi-directional communications. In general, the wireless communications device 1100 may include any number of transmitters 1108 and/or receivers 1110 for any number of communication systems and frequency bands. All or a portion of the transceiver 1104 may be implemented on one or more analog ICs, RF ICs (RFICs), mixed-signal ICs, etc.

The transmitter 1108 or the receiver 1110 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 1110. In the direct-conversion architecture, a signal is frequency-converted between RF and baseband in one stage. The super-heterodyne and direct-conversion architectures may use different circuit blocks and/or have different requirements. In the wireless communications device 1100 in FIG. 11, the transmitter 1108 and the receiver 1110 are implemented with the direct-conversion architecture.

In the transmit path, the data processor 1106 processes data to be transmitted and provides I and Q analog output signals to the transmitter 1108. In the exemplary wireless communications device 1100, the data processor 1106 includes digital-to-analog converters (DACs) 1112(1), 1112(2) for converting digital signals generated by the data processor 1106 into the I and Q analog output signals, e.g., I and Q output currents, for further processing.

Within the transmitter 1108, lowpass filters 1114(1), 1114(2) filter the I and Q analog output signals, respectively, to remove undesired signals caused by the prior digital-to-analog conversion. Amplifiers (AMPs) 1116(1), 1116(2) amplify the signals from the lowpass filters 1114(1), 1114(2), respectively, and provide I and Q baseband signals. An upconverter 1118 upconverts the I and Q baseband signals with I and Q transmit (TX) local oscillator (LO) signals through mixers 1120(1), 1120(2) from a TX LO signal generator 1122 to provide an upconverted signal 1124. A filter 1126 filters the upconverted signal 1124 to remove undesired signals caused by the frequency up-conversion as well as noise in a receive frequency band. A power amplifier (PA) 1128 amplifies the upconverted signal 1124 from the filter 1126 to obtain the desired output power level and provides a transmit RF signal. The transmit RF signal is routed through a duplexer or switch 1130 and transmitted via an antenna 1132.

In the receive path, the antenna 1132 receives signals transmitted by base stations and provides a received RF signal, which is routed through the duplexer or switch 1130 and provided to a low noise amplifier (LNA) 1134. The duplexer or switch 1130 is designed to operate with a specific receive (RX)-to-TX duplexer frequency separation, such that RX signals are isolated from TX signals. The received RF signal is amplified by the LNA 1134 and filtered by a filter 1136 to obtain a desired RF input signal. Down-conversion mixers 1138(1), 1138(2) mix the output of the filter 1136 with I and Q RX LO signals (i.e., LO_I and LO_Q) from an RX LO signal generator 1140 to generate I and Q baseband signals. The I and Q baseband signals are amplified by AMPs 1142(1), 1142(2) and further filtered by lowpass filters 1144(1), 1144(2) to obtain I and Q analog input signals, which are provided to the data processor 1106. In this example, the data processor 1106 includes analog-to-digital converters (ADCs) 1146(1), 1146(2) for converting the analog input signals into digital signals to be further processed by the data processor 1106.

In the wireless communications device 1100 of FIG. 11, the TX LO signal generator 1122 generates the I and Q TX LO signals used for frequency up-conversion, while the RX LO signal generator 1140 generates the I and Q RX LO signals used for frequency down-conversion. Each LO signal is a periodic signal with a particular fundamental frequency. A TX phase-locked loop (PLL) circuit 1148 receives timing information from the data processor 1106 and generates a control signal used to adjust the frequency and/or phase of the TX LO signals from the TX LO signal generator 1122. Similarly, an RX PLL circuit 1150 receives timing information from the data processor 1106 and generates a control signal used to adjust the frequency and/or phase of the RX LO signals from the RX LO signal generator 1140.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. An inductor package, comprising:
   a substrate; and
   an inductor coil comprising:
      a plurality of metal traces on the substrate, the plurality of metal traces parallel to each other,
         each metal trace of the plurality of metal traces comprising a first bonding section in a first plane and a second bonding section in the first plane; and
      a plurality of wedge electrical bonds each comprising:
         a first flat end portion coupled to the second bonding section of a first metal trace of the plurality of metal traces;
         a second flat end portion opposite the first flat end portion, the second flat end portion coupled to the first bonding section of a second metal trace of the plurality of metal traces adjacent to the first metal trace; and
         a raised wire above the first plane and coupled to the first flat end portion and the second flat end portion.
2. The inductor package of clause 1, wherein:
   the first flat end portion is parallel to the second bonding section; and
   the second flat end portion is parallel to the first bonding section.
3. The inductor package of clause 1 or 2, wherein:
   each metal trace of the plurality of metal traces further comprises:
      a first metal trace end; and
      a second metal trace end opposite the first metal trace end; and
   for each metal trace of the plurality of metal traces
      the first bonding section is adjacent to the first metal trace end; and
      the second bonding section is adjacent to the second metal trace end.
4. The inductor package of clause 3, wherein for each wedge electrical bond of the plurality of wedge electrical bonds:
   the first flat end portion comprises a first end co-planar with the second metal trace end; and
   the second flat end portion comprises a second end co-planar with the first metal trace end.
5. The inductor package of any of clauses 1-4, wherein each of the plurality of wedge electrical bonds has a U-shape.
6. The inductor package of any of clauses 1-5, wherein:
   each of the plurality of wedge electrical bonds further comprises:
      a first angled electrical wire coupled to the first flat end portion at a first angle; and
      a second angled electrical wire coupled to the second flat end portion at a second angle; and
   the raised wire is coupled to the first angled electrical wire and the second angled electrical wire.
7. The inductor package of clause 6, wherein each of the plurality of wedge electrical bonds has a trapezoid shape.
8. The inductor package of any of clauses 1-7, wherein:
   the first flat end portion has a length of 100 micrometers (μm); and
   the second flat end portion has a length of 100 μm.
9. The inductor package of any of clauses 1-8, wherein the raised wire forms an aperture between the raised wire and the first metal trace and the second metal trace.
10. The inductor package of any of clauses 1-9, further comprising an overmold comprising an overmolding material disposed on the substrate and the inductor coil.
11. The inductor package of clause 10, wherein for each of the plurality of wedge electrical bonds, the first flat end portion is exposed from a first side of the overmold and the second flat end portion is exposed from a second side of the overmold opposite the first side.
12. The inductor package of any of clauses 1 -11 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
13. A method of fabricating an inductor package, comprising:
   providing a substrate; and
   forming an inductor coil, comprising:
      forming a plurality of metal traces on the substrate, the plurality of metal traces parallel to each other,
         each metal trace of the plurality of metal traces comprising a first bonding section in a first plane and a second bonding section in the first plane; and
      forming a plurality of wedge electrical bonds each comprising:
         a first flat end portion;
         a second flat end portion opposite the first flat end portion; and
         a raised wire coupled to the first flat end portion and the second flat end portion;
         wherein forming the plurality of wedge electrical bonds comprises, for each wedge electrical bond of the plurality of wedge electrical bonds:
         coupling the first flat end portion to the second bonding section of a first metal trace of the plurality of metal traces; extending the raised wire above the first plane; and
         coupling the second flat end portion to the first bonding section of a second metal trace of the plurality of metal traces adjacent to the first metal trace.
14. The method of clause 13, wherein:
   coupling the first flat end portion to the second bonding section comprises coupling the first flat end portion co-planar to a second metal trace end of the second metal trace; and
   coupling the second flat end portion to the first bonding section comprises coupling the second flat end portion co-planar to a first metal trace end of the first metal trace.
15. The method of clause 13 or 14, wherein:
   each of the plurality of wedge electrical bonds further comprises:
      a first angled electrical wire coupled to the first flat end portion at a first angle; and
      a second angled electrical wire coupled to the second flat end portion at a second angle; and
   the raised wire is coupled to the first angled electrical wire and the second angled electrical wire.
16. The method of any of clauses 13-15, wherein extending the raised wire above the first plane for each of the plurality of wedge electrical bonds forms an aperture between the raised wire and the first metal trace and the second metal trace.
17. The method of any of clauses 13-16, further comprising forming an overmold comprising an overmolding material on the substrate and the inductor coil.
18. The method of clause 17, wherein forming the overmold further comprises exposing the first flat end portion of each of the plurality of wedge electrical bonds from a first side of the overmold and exposing the second flat end portion of each of the plurality of wedge electrical bonds from a second side of the overmold opposite the first side.
19. A method of fabricating a plurality of inductor packages, comprising:
   providing a substrate;
   forming a plurality of inductor coils, comprising:
      forming sets of metal traces on the substrate adjacent to each other from a street area therebeween, each set of metal traces comprising:
         a plurality of metal traces parallel to each other,
         each metal trace of the plurality of metal traces comprising a first bonding section in a first plane and a second bonding section in the first plane;
         each metal trace of the plurality of metal traces in the sets of metal traces extending along a common longitudinal axis to another metal trace of the plurality of metal traces in the sets of metal traces; and
      forming a plurality of wedge electrical bonds each extending across aligned metal traces in the sets of metal traces extending along the common longitudinal axis,
         each wedge electrical bond of the plurality of wedge electrical bonds coupling the first bonding section to the second bonding section of each of the aligned metal traces; and
   dicing the substrate in the street areas between adjacent sets of metal traces to form a plurality of inductor packages each having an inductor coil of the plurality of inductor coils.

What is claimed is:

1. An inductor package, comprising:
a substrate; and
an inductor coil comprising:
a plurality of metal traces on the substrate, the plurality of metal traces parallel to each other,
each metal trace of the plurality of metal traces comprising a first bonding section in a first plane and a second bonding section in the first plane; and
a plurality of wedge electrical bonds each comprising:
a first flat end portion coupled to the second bonding section of a first metal trace of the plurality of metal traces;
a second flat end portion opposite the first flat end portion, the second flat end portion coupled to the first bonding section of a second metal trace of the plurality of metal traces adjacent to the first metal trace; and
a raised wire above the first plane and coupled to the first flat end portion and the second flat end portion.

2. The inductor package of claim 1, wherein:
the first flat end portion is parallel to the second bonding section; and
the second flat end portion is parallel to the first bonding section.

3. The inductor package of claim 1, wherein:
each metal trace of the plurality of metal traces further comprises:
a first metal trace end; and
a second metal trace end opposite the first metal trace end; and
for each metal trace of the plurality of metal traces
the first bonding section is adjacent to the first metal trace end; and
the second bonding section is adjacent to the second metal trace end.

4. The inductor package of claim 3, wherein for each wedge electrical bond of the plurality of wedge electrical bonds:
the first flat end portion comprises a first end co-planar with the second metal trace end; and
the second flat end portion comprises a second end co-planar with the first metal trace end.

5. The inductor package of claim 1, wherein each of the plurality of wedge electrical bonds has a U-shape.

6. The inductor package of claim 1, wherein:
each of the plurality of wedge electrical bonds further comprises:
a first angled electrical wire coupled to the first flat end portion at a first angle; and
a second angled electrical wire coupled to the second flat end portion at a second angle; and
the raised wire is coupled to the first angled electrical wire and the second angled electrical wire.

7. The inductor package of claim 6, wherein each of the plurality of wedge electrical bonds has a trapezoid shape.

8. The inductor package of claim 1, wherein:
the first flat end portion has a length of 100 micrometers (μm); and
the second flat end portion has a length of 100 μm.

9. The inductor package of claim 1, wherein the raised wire forms an aperture between the raised wire and the first metal trace and the second metal trace.

10. The inductor package of claim 1, further comprising an overmold comprising an overmolding material disposed on the substrate and the inductor coil.

11. The inductor package of claim 10, wherein for each of the plurality of wedge electrical bonds, the first flat end portion is exposed from a first side of the overmold and the second flat end portion is exposed from a second side of the overmold opposite the first side.

12. The inductor package of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

13. A method of fabricating an inductor package, comprising:
providing a substrate; and
forming an inductor coil, comprising:
forming a plurality of metal traces on the substrate, the plurality of metal traces parallel to each other,
each metal trace of the plurality of metal traces comprising a first bonding section in a first plane and a second bonding section in the first plane; and
forming a plurality of wedge electrical bonds each comprising:
a first flat end portion;
a second flat end portion opposite the first flat end portion; and
a raised wire coupled to the first flat end portion and the second flat end portion;
wherein forming the plurality of wedge electrical bonds comprises, for each wedge electrical bond of the plurality of wedge electrical bonds:
coupling the first flat end portion to the second bonding section of a first metal trace of the plurality of metal traces;
extending the raised wire above the first plane; and
coupling the second flat end portion to the first bonding section of a second metal trace of the plurality of metal traces adjacent to the first metal trace.

14. The method of claim 13, wherein:
coupling the first flat end portion to the second bonding section comprises coupling the first flat end portion co-planar to a second metal trace end of the second metal trace; and
coupling the second flat end portion to the first bonding section comprises coupling the second flat end portion co-planar to a first metal trace end of the first metal trace.

15. The method of claim 13, wherein:
each of the plurality of wedge electrical bonds further comprises:
a first angled electrical wire coupled to the first flat end portion at a first angle; and
a second angled electrical wire coupled to the second flat end portion at a second angle; and
the raised wire is coupled to the first angled electrical wire and the second angled electrical wire.

16. The method of claim 13, wherein extending the raised wire above the first plane for each of the plurality of wedge electrical bonds forms an aperture between the raised wire and the first metal trace and the second metal trace.

17. The method of claim 13, further comprising forming an overmold comprising an overmolding material on the substrate and the inductor coil.

18. The method of claim 17, wherein forming the overmold further comprises exposing the first flat end portion of each of the plurality of wedge electrical bonds from a first side of the overmold and exposing the second flat end portion of each of the plurality of wedge electrical bonds from a second side of the overmold opposite the first side.

19. A method of fabricating a plurality of inductor packages, comprising:
providing a substrate;
forming a plurality of inductor coils, comprising:
forming sets of metal traces on the substrate adjacent to each other from a street area therebeween, each set of metal traces comprising:
a plurality of metal traces parallel to each other,
each metal trace of the plurality of metal traces comprising a first bonding section in a first plane and a second bonding section in the first plane;
each metal trace of the plurality of metal traces in the sets of metal traces extending along a common longitudinal axis to another metal trace of the plurality of metal traces in the sets of metal traces; and
forming a plurality of wedge electrical bonds each extending across aligned metal traces in the sets of metal traces extending along the common longitudinal axis,
each wedge electrical bond of the plurality of wedge electrical bonds coupling the first bonding section to the second bonding section of each of the aligned metal traces; and
dicing the substrate in the street areas between adjacent sets of metal traces to form a plurality of inductor packages each having an inductor coil of the plurality of inductor coils.
